(19) United States
(12) Patent Application Publication
(10) Pub. No.: US 2020/0384929 A1
(43) Pub. Date: Dec. 10, 2020

(54) ON-VEHICLE DISPLAY CONTROL SYSTEM AND DISPLAY CONTROL METHOD

(71) Applicant: MITSUBISHI ELECTRIC CORPORATION, Tokyo (JP)

(72) Inventors: Katsuki KOBAYASHI, Tokyo (JP); Daiki KUDO, Tokyo (JP)

(73) Assignee: MITSUBISHI ELECTRIC CORPORATION, Tokyo (JP)

(21) Appl. No.: 16/971,574

(22) PCT Filed: Feb. 27, 2018
(86) PCT No.: PCT/JP2018/007147

§ 371 Date: Aug. 20, 2020

(51) Int. Cl. B60R 11/02; B60R 11/04

(52) U.S. Cl. CPC B60R 11/0235; B60R 11/0264; B60R 2300/302; B60R 2300/802; B60R 11/04

(57) ABSTRACT

An on-vehicle display control system includes an image capturing means for capturing an image outside a vehicle, an angle detection means for detecting an angle between a direction of the vehicle at a predetermined timing of a past and a direction of the vehicle at present, a determination means to compare the angle detected by the angle detection means with a predetermined angle and to determine whether to display the image outside the vehicle captured by the image capturing means on a display on the basis of the comparison result, and a display control means to control display of the image on the display on the basis of a determination result of the determination means. Thus, it is possible to suitably control the display timing of the vehicle surrounding image in accordance with a situation of the vehicle.

### TECHNICAL FIELD

The present invention relates to an on-vehicle display control system and a display control method that can suitably control the display timing of a vehicle surrounding image in accordance with the situation of the vehicle.

### BACKGROUND ART

In recent years, technologies have been in progress to make drivers aware of the vehicle surrounding situation and encourage safe driving. As an example of the technologies, a device has been developed in which a camera is provided for capturing a vehicle surrounding image and an image captured by the camera is displayed on a display in a vehicle for a driver to visually check the image.

If the vehicle surrounding image is always displayed on the display inside the vehicle, the vehicle surrounding image will be displayed still at a timing when the image does not need to be provided to the driver, resulting in drawing the user's attention unnecessarily. Also, it is not preferable from the viewpoint of efficient use of the display. There may be a case in which the driver performs a display instruction operation on the display at a timing when the driver wants to check the surrounding situation, and then the surrounding image is shown on the display. However, it may be troublesome for the driver to directly perform the instruction operation, which also may lead to a possibility of causing danger.

Therefore, there has been proposed a vehicle surrounding display device that detects a gaze direction of a driver and automatically displays a vehicle surrounding image on the basis of the gaze direction (for example, Patent Document 1).

### CITATION LIST

### Patent Document

Patent Document 1: Japanese Unexamined Patent Application Publication No. 2011-184044

### SUMMARY OF THE INVENTION

### Technical Problem

The vehicle surrounding display device disclosed in Patent Document 1 determines a vehicle surrounding region to be shown on the display on the basis of the driver's face direction or the gaze direction. Thus, in a situation such as in an intersection where the face direction or the gaze direction changes frequently in checking the vehicle surrounding, the display contents may also frequently change, so that it may be possibly inconvenient for the user.

The present invention has been made to solve the above-mentioned problem and to obtain an on-vehicle display control system and a display control method that can suitably control the display timing of a surrounding image in accordance with a situation of the vehicle.

### Solution to Problem

In order to solve the above-mentioned problems and achieve an object, the on-vehicle display control system according to the present disclosure includes an image capturing means to capture an image outside a vehicle, an angle detection means to detect an angle between a vehicle orientation at a past predetermined timing and a current vehicle orientation, a determination means to compare the angle detected by the angle detection means with a predetermined angle and to determine whether to display the image outside the vehicle captured by the image capturing means on a display on the basis of the comparison result, and a display control means to control display of the image on the display on the basis of a determination result of the determination means.

### Advantageous Effects of Invention

According to the present invention, it is possible to suitably control the display timing of the surrounding image in accordance with the situation of the vehicle.

### BRIEF DESCRIPTION OF DRAWINGS

FIG. 1 is a block diagram showing an example of a hardware configuration of an on-vehicle display control system in Embodiment 1.

FIG. 2 is a block diagram showing an example of a function configuration of the on-vehicle display control system in Embodiment 1.

FIG. 3 is a flow diagram showing an example of a process flow for determining in a determination unit in Embodiment 1.

FIG. 4 is a conceptual diagram showing an example of a traveling direction of a vehicle and an image capturing range of an external camera in Embodiment 1.

FIG. 5 is a flow diagram showing an example of a process flow of a first determination process in Embodiment 1.

FIG. 6 is a conceptual diagram showing an example of a traveling direction of a vehicle and the image capturing range of the external camera in Embodiment 1.

FIG. 7 is a flow diagram showing an example of a process flow of a second determination process in Embodiment 1.

FIG. 8 is a block diagram showing an example of a functional configuration of an on-vehicle display control system in Embodiment 2.

FIG. 9 is a conceptual diagram showing an example of a traveling direction of a vehicle and an image capturing range of an external camera in Embodiment 2.

FIG. 10 is a flow diagram showing an example of a process flow of a third determination process in Embodiment 2.

### DESCRIPTION OF EMBODIMENTS

Hereinafter, embodiments of an on-vehicle display control system and a display control method according to the present invention will be described in detail referring to the drawings.

### Embodiment 1

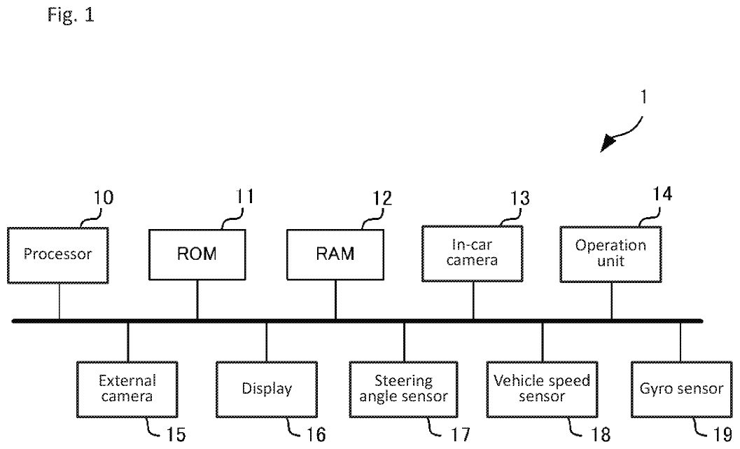

FIG. 1 is a block diagram showing an example of a hardware configuration of an on-vehicle display control system in the present embodiment.

The on-vehicle display control system 1 is installed, for example, on a four-wheeled vehicle and has a function of showing an image outside the vehicle at an appropriate timing on a display in the vehicle.

The on-vehicle display control system 1 in the present embodiment includes a processor 10, a read only memory (ROM) 11, a random access memory (RAM) 12, an in-car camera 13, an operation unit 14, an external camera 15, a display 16, a steering angle sensor 17, a vehicle speed sensor 18, and a gyro sensor 19.

The processor 10 is a calculation processing circuit that executes various calculation processes, and is hardware that can be referred to by various names, such as a processor, a calculation processing circuit, an electric circuit, and a controller. The processor 10 is configured with a set of one or more calculation processing circuits. The processor 10 reads out a program from the ROM 11 and loads these into the RAM 12 to perform a calculation processing.

The ROM 11 is a nonvolatile storage device for storing one or more programs.

The RAM 12 is a volatile storage device used by the processor 10 as a loading area for programs and various information.

In the present embodiment, the ROM is described as an example of a storage device that stores a program to be executed by the processor 10. However, the storage device is not limited to this, and may be a nonvolatile large-capacity storage device such as a hard disk drive (HDD) and a solid state drive (SSD) that are referred to as a storage. In addition, storage devices including the storage may be collectively referred to as memory.

The in-car camera 13 is a camera (image capturing device) that is installed so as to face the driver's seat of the vehicle, and has a function of capturing an image of a user (driver) sitting in the driver's seat. The in-car camera 13 captures the face and upper body of the user and outputs captured images to the processor 10. Further, as a typical example of the in-car camera 13, a charge coupled device (CCD) camera, a complementary metal oxide semiconductor (CMOS) camera, or the like can be used.

The operation unit 14 is an input device for the user to input information to the on-vehicle display control system 1. In the present embodiment, a touch panel provided on the display 16 is exemplified, but other examples of input devices include various hardware such as buttons.

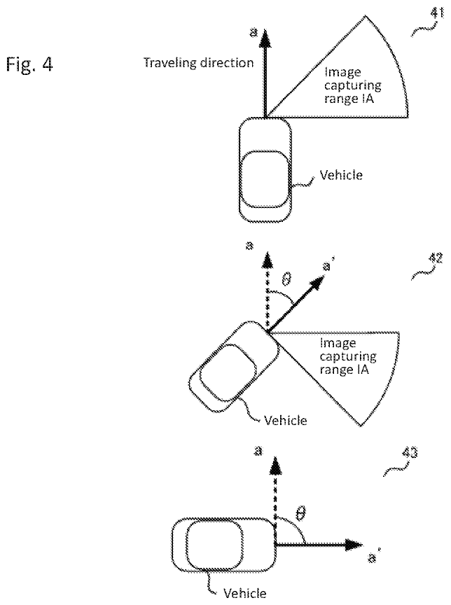

The external camera 15 is a camera (image capturing device) provided for capturing an image outside the vehicle. In the present embodiment, the external camera 15 is installed at a position such that a vehicle surrounding area likely to be a blind area for a driver can be captured. The details will be described referring to FIG. 4 or others, and the external camera 15 is provided at a position (front side of vehicle) such that an image outside the vehicle on the oblique front and side of the driver can be captured. For the external camera 15, a plurality of cameras for capturing images of the vehicle surrounding may be provided, one camera capable of capturing an image of a wide angle such as a 180-degree camera may be installed, and the displayed area may be appropriately changed. The external camera 15 has a function of outputting the captured images to the processor 10.

An image captured by the external camera 15 can be shown by the display 16 installed at a position where a driver in the vehicle can check visually. In the present embodiment, an image on a screen for setting and operating the on-vehicle display control system 1 can be displayed. The user can set and operate the on-vehicle display control system 1 by touching the operation unit 14 provided on the screen of the display 16. Further, for example, map information of a car navigation system or the like may be displayed. Further, the display 16 may be a device such as a head up display (HUD) that projects and displays an image on a specific member.

The steering angle sensor 17 is a sensor that detects the steering angle of the vehicle, and outputs to the processor 10, an electric signal corresponding to the steering angle depending on the operation of the steering wheel.

The vehicle speed sensor 18 is a sensor that detects the speed of the vehicle, and outputs to the processor 10, an electric signal (vehicle speed pulse) corresponding to the wheel speed.

The gyro sensor 19 is a sensor that detects an angular velocity (gyro), and the processor 10 can detect a turning speed, a turning angle, or the like of the vehicle on the basis of the angular velocity information.

Next, the functional configuration of the on-vehicle display control system 1 will be described.

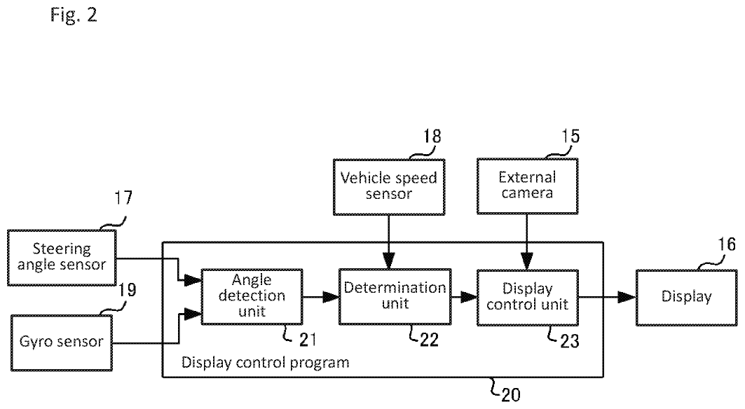

FIG. 2 is a block diagram showing an example of a functional configuration of the on-vehicle display control system in the present embodiment.

The display control program 20 shown in FIG. 2 is a program stored in the ROM 11 and loaded to the RAM 12 to be executed by the processor 10. With this program, a function of appropriately switching between display and non-display of the outside image captured by the outside camera 15 is executed to the display 16.

The display control program 20 includes an angle detection unit 21, a determination unit 22, and a display control unit 23.

The angle detection unit 21 has a function of detecting the angle at which the vehicle is facing on the basis of information input from the steering angle sensor 17 and the gyro sensor 19. The angle detection unit 21 calculates an angle θ between the traveling direction of the vehicle at the start of turning left or right and the traveling direction of the vehicle during turning left or right. Then, the angle detection unit 21 outputs to the determination unit 22 the angle θ between the traveling direction of the vehicle at the start of turning left or right and the traveling direction of the vehicle during turning left or right.

The determination unit 22 has a function of determining whether or not to switch between display and non-display of the vehicle surrounding image captured by the external camera 15 (a blind area image for the driver) on the basis of the information of the angle θ input from the angle detection unit 21 and the vehicle speed input from the vehicle speed sensor 18. The determination process performed by the determination unit 22 will be described later in detail referring to the drawings.

The display control unit 23 has a function of controlling display or non-display of the image captured by the external camera 15 on the display 16 on the basis of the determination result of the determination unit 22.

Next, the determination in switching between display and non-display of the vehicle surrounding image by the determination unit 22 will be described.

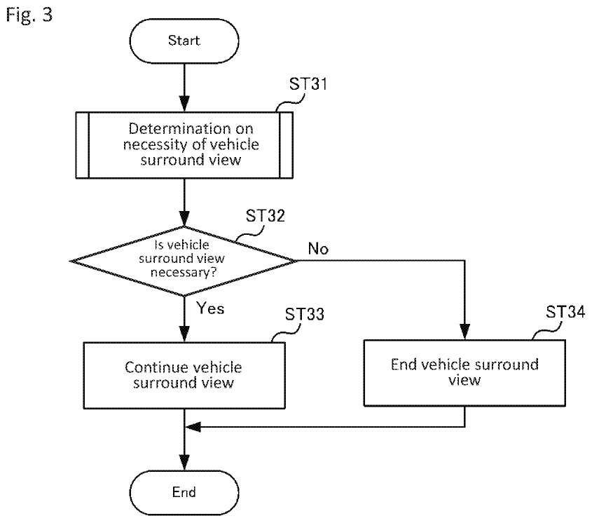

FIG. 3 is a flow diagram showing an example of a determination process flow of the determination unit 22 in the present embodiment.

First, when the vehicle turns right or left, the on-vehicle display control system 1 shows, on the display 16, an image of the surrounding of the vehicle that is likely to be a blind area for the driver, the image being captured by the external camera 15. Hereinafter, this display process is also referred to as vehicle surround view.

When the vehicle starts turning right and left, the angle detection unit 21 calculates the angle θ between the traveling direction of the vehicle at the start of turning right and left and the current traveling direction of the vehicle on the basis of information input from the steering angle sensor 17 and the gyro sensor 19 and outputs the angle to the determination unit 22.

The determination unit 22 performs a determination process as to whether or not the vehicle surround view is necessary on the basis of the information on the angle θ input from the angle detection unit 21 and the vehicle speed input from the vehicle speed sensor 18 (Step ST31). For the determination, the determination unit 22 of the present embodiment can execute two types of determination process, and details of each determination process will be described later.

When determining that the vehicle surround view is necessary (Step ST32: Yes), the determination unit 22 outputs to the display control unit 23 an instruction that the vehicle surround view is necessary, and the display control unit 23 continues the vehicle surround view (Step ST33).

When determining that the vehicle surround view is unnecessary (Step ST32: No), the determination unit 22 outputs to the display control unit 23 an instruction that the vehicle surround view is unnecessary, and the display control unit 23 ends the vehicle surround view (Step ST34).

Thus, a series of process flows end.

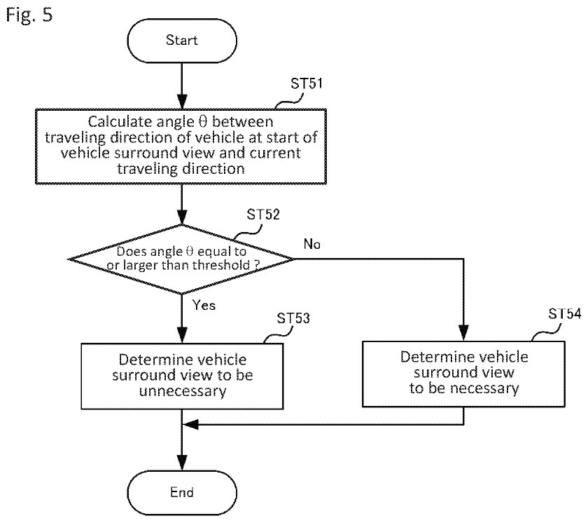

Referring to FIGS. 4 and 5, an example of the process of determining whether the vehicle surround view is necessary or not in step ST31 described above will be described below.

FIG. 4 is a conceptual diagram showing an example of the traveling direction of the vehicle and the image capturing range of the external camera in the present embodiment.

FIG. 4 shows a traveling direction a of the vehicle at the point where the vehicle started turning right at an intersection etc. and the vehicle surround view started (vehicle surround view start point), and traveling directions a′ of the vehicle during the right turn. In addition, the angle between the traveling direction a and the traveling direction a′ is indicated as θ. Also, the image capturing range of the external camera 15 is shown as an image capturing range IA. When the vehicle starts turning right at an intersection or the like (State 41), the traveling direction a′ during the right turn gradually shifts rightward from the traveling direction a at the start of the right turn (State 42). During the time, the image capturing range IA of the external camera 15 also changes in accordance with the traveling direction of the vehicle. In the determination process shown in FIGS. 4 and 5 (hereinafter also referred to as a first determination process), when θ becomes close to a right angle, it is determined that the vehicle surround view is unnecessary. That is, it is determined that the vehicle surround view is necessary during the state 42. Then, when the angle θ becomes a value close to a right angle, the right turn of the vehicle is almost completed (State 43), so that it is determined that the vehicle surround view is unnecessary because of the right turn completion.

Note that, in this embodiment, it is exemplified that the right turn start time is determined to be at the timing when the steering angle sensor 17 or the gyro sensor 19 detects that the vehicle turns at a predetermined angle or more. The right turn start time may be determined to be at the timing when the vehicle speed falls below a certain value, may be determined on the basis of the operation of the blinker, or may be determined from map information of the traveling spot.

FIG. 5 is a flow diagram showing an example of the process flow of the first determination process in the present embodiment.

In the first determination process, the angle detection unit 21 calculates the angle θ between the traveling direction a of the vehicle at the start of the vehicle surround view (timing at the start of turning left or right) and the current traveling direction a′ of the vehicle on the basis of the information input from the steering angle sensor 17 and the gyro sensor 19 (Step ST51).

The determination unit 22 determines that the vehicle surround view is unnecessary if the angle θ is equal to or larger than a threshold (Step ST52: Yes) on the basis of the angle θ input from the angle detection unit 21 (Step ST53). The vehicle surround view is a display function for capturing an image of an area that is likely to be the blind area for the user and displaying the image on the display 16 to assist the user's visibility at the time of turning left or right. When the angle is equal to or larger than the threshold, the determination unit 22 assumes that turning left or right is completed and determines that vehicle surround view is unnecessary. In the present embodiment, the threshold is illustrated as being a right angle) (90°), but this is not a limitation and may be set to another suitable angle.

Further, the threshold of the angle θ may be set using map information. That is, an angle φ between a straight traveling direction and a left or right turn direction from the road shape is calculated. It is assumed that turning left or right is completed when the angle θ becomes close to the angle φ. Then, the vehicle surround view may be determined to be unnecessary.

By the flow, the on-vehicle display control system 1 can provide the user with an image of the surrounding outside the vehicle that can be a blind area for the user when the vehicle is turning left or right, and the display can be terminated at a timing when providing of the image to the user is unnecessary. With this operation, the on-vehicle display control system 1 can appropriately control the display timing of the surrounding image in accordance with the situation of the vehicle.

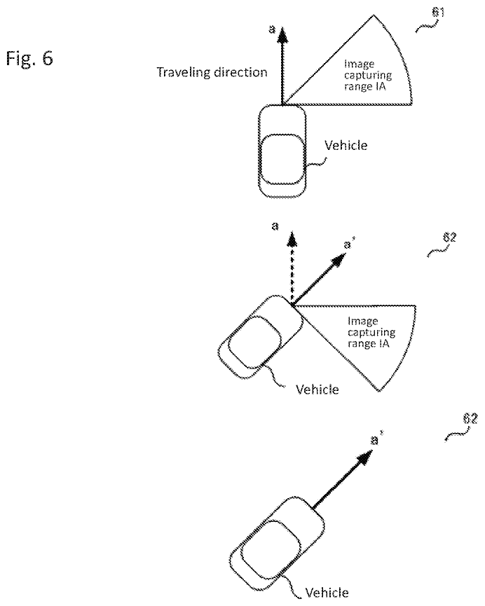

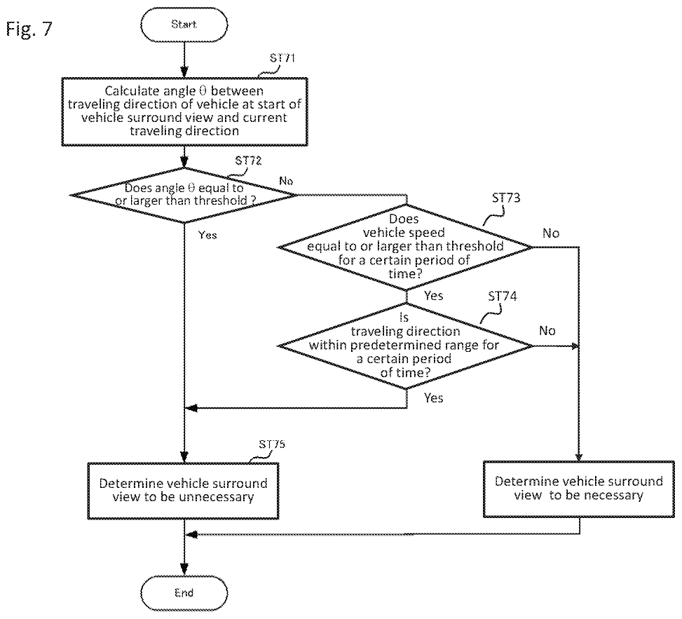

Next, another example of the process for determining the necessity of the vehicle surround view in Step ST31 described in FIG. 3 will be described. Although the first determination process using the angle θ has been described referring to FIGS. 4 and 5, in the following, a second determination process using vehicle speed information etc. in addition to the angle θ will be described using FIGS. 6 and 7.

FIG. 6 is a conceptual diagram showing an example of a traveling direction of the vehicle and an image capturing range of the external camera in the present embodiment. When the threshold is set to 90°, the first determination process will work effectively in the case of a left or right turn is made at a right angle. However, the left or right turn at a right angle is not always the case, and there is a case where the left or right turn is completed at an angle being smaller than a right angle.

When the vehicle starts turning right at an intersection or the like (State 61), the traveling direction a′ during the right turn gradually shifts rightward from the traveling direction a at the start of the right turn (State 62). At this time, if the road is diagonal to the traveling direction a, the right turn is completed without the angle θ reaching a right angle (State 63).

In such a case, the vehicle typically slows down from a start point of the vehicle surround view and starts increasing the vehicle speed after the right turn is completed (or immediately before the right turn is completed). Then, the vehicle speeds up further, and the traveling direction is stabilized to resume traveling. Thus, in the second determination process, in addition to determining whether or not the angle θ is equal to or larger than the predetermined value, whether or not the vehicle speed is equal to or larger than a threshold for a certain period of time and whether the traveling direction is within a predetermined range for a certain period of time are determined, and thereby the necessity or unnecessity of the vehicle surround view is determined.

A specific flow will be described below.

FIG. 7 is a flow diagram showing an example of a process flow of the second determination process in the present embodiment.

In the second determination process, the angle detection unit 21 calculates the angle θ between the traveling direction a of the vehicle at the start of the vehicle surround view (timing at the start of turning left or right) and the current traveling direction a′ of the vehicle on the basis of the information input from the steering angle sensor 17 and the gyro sensor 19 (Step ST71).

If the angle θ is less than the threshold (step ST72: No), the determination unit 22 determines whether the vehicle speed is equal to or larger than the threshold for a certain period of time on the basis of the vehicle speed information input from the vehicle speed sensor 18 (Step ST73).

If the vehicle speed is equal to or larger than the threshold for a certain period of time in step ST73 (Step ST73: Yes), the determination unit 22 determines whether the traveling direction is within the predetermined range for a certain period of time (step ST74). Here, by determining whether the change in the angle θ is equal to or less than a predetermined value for a certain period of time (whether the rate of change in the angle θ is equal to or less than a predetermined value in a certain period of time), the determination unit 22 determines whether the traveling direction is within the predetermined range for a certain period of time or more.

If the angle θ is equal to or larger than the threshold in step ST72 (Step ST72: Yes) or if the traveling direction is within the predetermined range for a certain period of time in step ST74 (Step ST74: Yes), the determination unit 22 determines that vehicle surround view is not necessary (Step ST75). That is, if the angle θ is equal to or larger than the threshold, the determination unit 22 determines that the right or left turn has been completed. Further, even if the angle θ is less than the threshold, the determination unit 22 determines that the right or left turn has been completed if the vehicle speed is equal to or larger than the threshold for a certain period of time and the traveling direction is within the predetermined range for a certain period of time. This is because, as described above, the vehicle typically slows down from the start point of the vehicle surround view, increases the vehicle speed after completing the right turn, stabilizes the traveling direction, and resumes traveling. If the vehicle speed is equal to or larger than the threshold for a certain period of time and the traveling direction is within the predetermined range for a certain period of time, the determination unit 22 determines that the right or left turn has been completed even when the angle θ is less than the threshold.

If the vehicle speed is not equal to or larger than the threshold for a certain period of time in step ST73 (Step ST73: No) or if the traveling direction is not within the predetermined range for a certain period of time in step ST74 (Step ST74: No), the determination unit 22 determines that the right or left turn has not been completed and the vehicle surround view is necessary (Step ST76).

Here, the threshold in the determination of the vehicle speed may use a prescribed value, may use the speed immediately before reaching the start point of the vehicle surround view, or may use the accelerator or brake pedal depression amount. Information outside the vehicle such as map information or the legal speed limit may also be used. Further, in the determination of the stability of the traveling direction, a method determines the direction to be stable when the amount of change in the traveling direction has become less than or equal to a certain value for a certain period of time, or another method determines the direction to be stable when the number of times the amount of change in the traveling direction has become less than or equal to a certain value exceeds a certain value.

According to this flow, the on-vehicle display control system 1 can appropriately switch between display and non-display of an image of the surrounding outside the vehicle even when the vehicle completes the right or left turn at an angle different from an assumed right or left turn angle.

### Embodiment 2

Next, Embodiment 2 according to the present invention will be described. In the following description, configurations similar to those in Embodiment 1 will be described with the same names and numbers assigned thereto.

The hardware configuration of an on-vehicle display control system according to Embodiment 2 is the same as that of Embodiment 1.

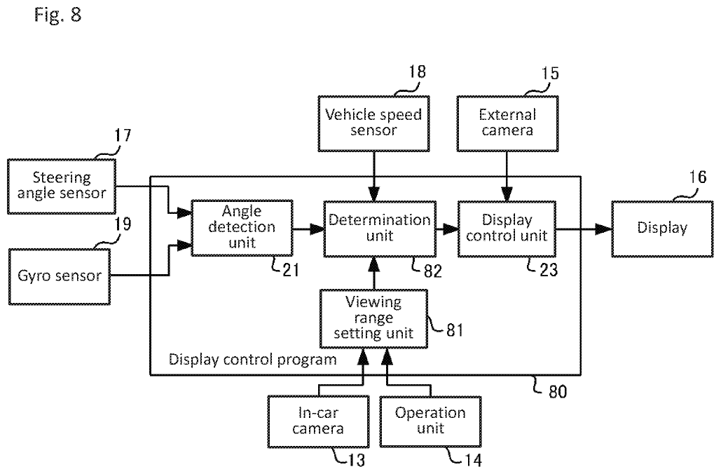

FIG. 8 is a block diagram showing an example of a functional configuration of the on-vehicle display control system according to the present embodiment.

The display control program 80 according to the present embodiment further includes a viewing range setting unit 81 in addition to the display control program 20 according to the Embodiment 1.

The viewing range setting unit 81 has a function of setting a viewing range of the driver. Here, the viewing range of the driver means a range that the driver can see from the driver's seat or a range that is not a blind area. As a method of setting the viewing range of the driver, a camera that captures an image of the front from the driver's seat may be used, and the angle of view of the camera may be set as the viewing range, or the line of sight of the driver may be detected on the basis of an image of the in-car camera 13 that captures the driver, and thus the range that is visually recognizable may be calculated from the direction of the line of sight. In addition, a viewing range outside the vehicle that is visually recognizable by the driver may be set by estimating the position of the driver's line of sight and the driver's age on the basis of an image of the in-car camera 13. Further, a range that is manually calibrated by the driver using the operation unit 14 before the driver starts driving may be set as the viewing range. Further, the viewing range of the driver may be set by a method combining the above.

The determination unit 82 has a function to calculate a degree of overlap R between the viewing range of the driver set by the viewing range setting unit 81 and the range that is a blind area for the driver at the start of turning right or left and to determine the necessity of the vehicle surround view on the basis of the degree of overlap R. Here, the range that is the blind area for the driver at the start of turning right or left may be referred to as an image capturing range (initial image capturing range) that the camera 15 outside the vehicle captures an image at the start of turning right or left. The degree of overlap R can be calculated from the viewing range of the driver set by the viewing range setting unit 81, the angle θ input from the angle detection unit 21, the information on the vehicle speed input from the vehicle speed sensor 18, and the range (initial image capturing range) that is the blind area for the driver at the start of turning right or left.

The display control unit 23 has a function of controlling display or non-display of the image captured by the external camera 15 on the display 16 on the basis of the determination result of the determination unit 82.

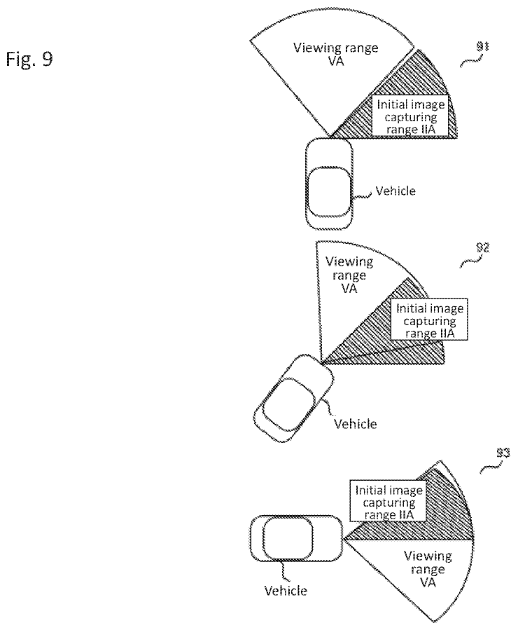

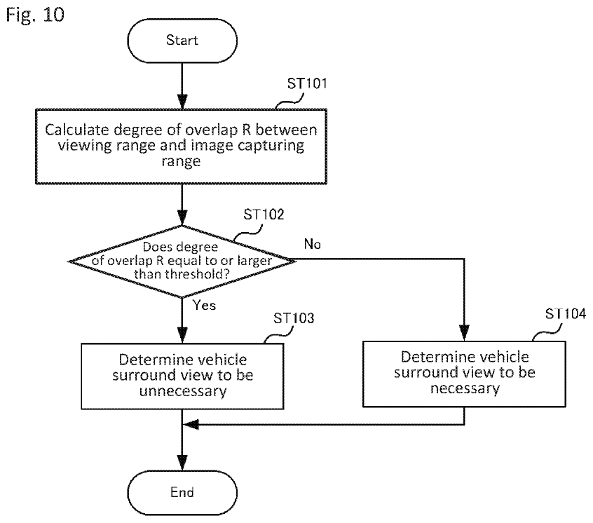

Next, an example of the determination process of the necessity of the vehicle surround view according to Embodiment 2 will be described. In the present embodiment, the determination unit 82 also executes the same processes with the flow shown in FIG. 3, but the process for determining the necessity of the vehicle surround view in Step ST31 (third determination process) is different from that of Embodiment 1. The third determination process different from that of Embodiment 1 will be described referring to FIGS. 9 and 10.

FIG. 9 is a conceptual diagram showing an example of the traveling direction of the vehicle and the image capturing range of the external camera in the present embodiment.

FIG. 9 shows a viewing range VA of the driver set by the intersection viewing range setting unit 81 and an initial image capturing range IIA of the external camera 15 at the start of the right turn of the vehicle in an intersection or the like.

When the vehicle starts turning right at an intersection or the like (state 91), the image capturing range captured by the external camera 15 at the start of the right turn is the initial image capturing range IIA. Because the range of the driver's blind area is captured at the start of the right turn, there is no overlapping area between the viewing range VA of the driver and the initial image capturing range IIA as shown in the state. In the present embodiment, no overlapping area is exemplified, but this is not a limitation, and thus the overlapping area may be small.

When a right turn is started and the orientation of the vehicle shifts rightward (state 92), the overlapping area between the viewing range VA of the driver and the initial image capturing range IIA captured by the external camera 15 at the start of the right turn gradually increases. When the viewing range VA of the driver completely overlaps with the initial image capturing range IIA, or when the degree of overlap is greater than a predetermined value (state 93), the right turn of the vehicle is almost completed, and the determination unit 82 determines that the vehicle surround view is no longer needed.

As described above, in the third determination process, the degree of overlap between the viewing range VA of the driver and the initial image capturing range IIA is calculated, and the necessity of the vehicle surround view is determined on the basis of the degree of overlap.

FIG. 10 is a flow diagram showing an example of a process flow of the third determination process in the present embodiment.

In the third determination process, the determination unit 82 calculates the degree of overlap R between the viewing range VA of the driver set by the viewing range setting unit 81 and the initial image capturing range IIA that the external camera 15 captures when the vehicle started turning left or right (step ST101). The initial image capturing range IIA may be set with an assumed predetermined range as an initial value in advance by the determination unit 82, or may be set on the basis of the image captured by the external camera 15 at the start of turning left or right.

If the degree of overlap R calculated in Step ST101 is equal to or larger than a predetermined value (Step ST102: Yes), the determination unit 82 determines that the vehicle surround view is unnecessary (Step ST103).

When the calculated degree of overlap R in Step ST101 is less than the predetermined value (Step ST102: No), the determination unit 82 determines that the vehicle surround view is unnecessary (Step ST104).

In the third determination process, after determining whether the range that is a blind area from the driver at the start of turning left or right still remains as the blind area or not in the middle of turning left or right, and it is determined whether the vehicle surround view is necessary or not.

In the above, the method is exemplified in which the viewing range VA of the driver and the initial image capturing range IIA are obtained, and the degree of overlap R is calculated. However, this is not a limitation. As another method, for example, the direction of the image capturing range at the start of the vehicle surround view is stored, and the direction of the image capturing is changed in accordance with the traveling direction of the vehicle so that the degree of overlap R is calculated on the basis of the angle between the direction of the viewing range (the traveling direction) and the direction of the image capturing range.

According to the embodiments of the present invention described above, the vehicle surround view can be maintained at situations when the driver needs to check the surroundings, such as the situation of passing through an intersection or entering a road from a garage or a parking lot, and the display image can be switched to the original (for example, to the car navigation image) at an appropriate timing after the above situations.

Further, it is possible to suitably control the display timing of the vehicle surrounding image in accordance with the situation of the vehicle.

The present disclosure is not limited to the above-described embodiments, and various modifications and applications are possible. For example, in the process for determining the necessity of the vehicle surround view, information inside and outside of the vehicle other than the vehicle speed and the traveling direction may be used. Further, in the process for determining the necessity of the vehicle surround view, an input mode other than a camera may be used. For example, by using a voice input, voice of the driver may be analyzed to determine whether display is necessary or not.

The present disclosure has been described on the basis of the embodiments. It goes without saying that various modifications and variations can be made to the components and the combinations of each of the processes in these embodiments.

### Description of Symbols

1 on-vehicle display control system

10 processor

11 ROM

12 RAM

13 in-car camera

14 operation unit

15 external camera

16 display

17 steering angle sensor

18 vehicle speed sensor

19 gyro sensor

20 display control program

21 angle detection unit

22 determination unit

23 display control unit

80 display control program

81 viewing range setting unit

82 determination unit

1. An on-vehicle display control system comprising:
an image capturing camera to capture an image outside a vehicle;
an angle detecting circuitry to detect an angle between a vehicle orientation at a past predetermined timing and a current vehicle orientation;
a speed detecting circuitry to detect a speed of the vehicle;
a determining circuitry to compare the angle detected by the angle detecting circuitry with a predetermined angle, to make a judgement on whether or not a traveling direction of the vehicle is within a predetermined range for a certain period of time, and to determine whether to display the image outside the vehicle captured by the image capturing camera on a display on the basis of the judgement result, the speed detected by the speed detecting circuitry, and the comparison result; and
a display controlling circuitry to control display of the image on the display on the basis of a determination result of the determining circuitry, wherein
the determining circuitry determines that the image outside the vehicle is unnecessary to be displayed on the display in a case where the angle detected by the angle detecting circuitry is equal to or larger than the predetermined angle, or in a case where the angle detected by the angle detecting circuitry is smaller than the predetermined angle and the speed of the vehicle is equal to or larger than a threshold value for a certain period of time, and the traveling direction of the vehicle is within the predetermined range for a certain period of time.

2-4. (canceled)

5. The on-vehicle display control system according to claim 1, further comprising the display.

6. A display control method comprising:
capturing an image outside a vehicle;
detecting an angle between a vehicle orientation at a past predetermined timing and a current vehicle orientation;
detecting a speed of the vehicle;
determining whether to display the image outside the vehicle on a display by comparing the detected angle with a predetermined angle, by making a judgement on whether or not a traveling direction of the vehicle is within a predetermined range for a certain period of time, and on the basis of the judgement result, the detected speed, and the comparison result; and
controlling display of the image on the display on the basis of the determination result, wherein
in the determining, the image outside the vehicle is unnecessary to be displayed on the display in a case where the detected angle is equal to or larger than the predetermined angle, or in a case where the detected angle is smaller than the predetermined angle and the speed of the vehicle is equal to or larger than a threshold value for a certain period of time, and the traveling direction of the vehicle is within the predetermined range for a certain period of time.

7-10. (canceled)
